(19) United States
(12) Patent Application Publication
(10) Pub. No.: US 2025/0299143 A1
(43) Pub. Date: Sep. 25, 2025

(54) AB Testing on Edge Computing System

(71) Applicant: NOSTRA, INC., San Francisco, CA (US)

(72) Inventors: Scott Sanders, Layton, UT (US); Mario Tinoco, Davis, CA (US)

(21) Appl. No.: 18/612,043

(22) Filed: Mar. 21, 2024

(51) Int. Cl. G06Q 10/0639; G06F 16/958

(52) U.S. Cl. CPC G06Q 10/06393; G06F 16/986

(57) ABSTRACT

A computer-implemented method executed by an edge computing system to optimize the delivery and performance of HTML webpages is disclosed. This method involves transmitting a request for a webpage, receiving and modifying the webpage, and selecting either the original or modified version to respond to client requests based on a probability. Performance metrics related to the chosen version are received from client devices and tracked using tracking software. The probabilities of sending different versions to clients are updated based on performance metrics via an edge-side bias module. The disclosure also includes variations such as using generative AI or a WYSIWYG interface for webpage modification, operating in a distributed edge computing system, tracking metrics like conversion rates or revenue, and discarding low-performing versions.

### BACKGROUND

Edge computing systems play pivotal roles in shaping the modern internet landscape. Edge computing brings computational resources closer to the end-users, reducing latency and enhancing the overall user experience. By distributing processing power and data storage across a network of edge devices, it allows for quicker response times and more efficient data processing, making it ideal for applications like IoT, real-time analytics, and augmented reality.

AB testing, also known as split testing, involves showing different variants of a site to statistically significant populations of users in order to identify the highest converting layout. Experiment variations may include differences in elements of a user interface presented to different users, wording differences in the texts addressed to different users, etc. Feedback from the users in the form of metrics are measured and sent back to the servers and compiled to produce experiment results. Important metrics, sometimes called key performance indicators, can include conversion rate, click-through rate, session length, upgrades to premium, or the amount of revenue generated. Comparing the metrics of the various versions of the site helps determine which experiment variation best accomplishes a particular goal of the experiment.

AB testing on edge computing systems is a strategic approach to enhance the performance of the experiments and site. This process involves pre-building and caching tests on local servers at the network's edge, closer to end-users. Executing layout options on the edge before the page loads eliminates latency to allow quick and efficient results. Proving optimal layouts through variant versions of the site, shifting traffic at the edge nodes from failed experiments, and utilizing personalized layouts, maximizes results even before the test concludes.

### SUMMARY

Methods and systems which involve AB testing on edge computing systems are disclosed herein. More specifically, methods and systems to enhance the performance and experiments of sites are disclosed herein. As used herein, the term “AB testing” refers to showing different variants of a site to statistically significant populations of users to identify an experiment variation that best accomplishes a particular goal of the experiment. In traditional methods of AB testing, key performance indicators of the live site suffer in the short term when non-optimized versions of the website are shown to end users during the experiment. Specific embodiments of the invention disclosed herein use AB testing on edge computing systems to execute layout options on the edge before the site loads on the client device.

In accordance with specific embodiments disclosed herein, a node of an edge computing system requests a HTML webpage using a network to an origin server. In specific embodiments, the method disclosed describes a node of an edge computing system, which can be a high-performance mainframe server located in close geographic proximity to the end user, which receives an HTML webpage transmitted by an origin server. In specific embodiments, the node of the edge computing system modifies the HTML webpage to create a variant version of the HTML webpage using HTML source code.

In specific embodiments, the node of an edge computing system receives from a client device a request for an HTML webpage. Then in response to the request, the node transmits a version of the HTML webpage to the client device.

Real-time updates indicating the status of experimental variants of a site are sometimes neglected in the optimization of short-term performance of a site during AB testing. To address this, specific embodiments involve tracking software for performance measurement located on a node of an edge computer system that monitors the metrics of experimental variants of the site. By caching the HTML webpage in an edge node of an edge computing system, the latency inherent in traditional AB testing systems is reduced-allowing for dynamic traffic allocation.

The method disclosed above can be performed such that the issue of short-term revenue loss in traditional AB testing can be resolved by dynamically reallocating traffic away from failed experiments. In traditional AB testing methods, underperforming versions of the site can be shown at a high frequency throughout the course of testing, without accounting for results of the experiments. In specific embodiments, probabilities of sending different versions of the site are adjusted dynamically, throughout the course of testing, to improve the performance of the site in a particular domain of measurement.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a flow chart of computer-implemented methods in accordance with specific embodiments of the invention disclosed herein.

FIG. 2 illustrates a flow chart of an edge node choosing a version of an HTML webpage to transmit in accordance with specific embodiments of the invention disclosed herein.

FIG. 3 illustrates a flow chart of biasing probabilities associated with versions of an HTML webpage to transmit in accordance with specific embodiments of the invention disclosed herein.

FIG. 4 illustrates a flow chart of an edge node sending a high performing variant version of an HTML webpage to another edge node for testing.

FIG. 5 illustrates a system architecture of an edge computing system in accordance with specific embodiments of the invention disclosed herein.

FIG. 6 illustrates a ladder diagram of a client device, an edge node, and an origin server conducting methods that are in accordance with specific embodiments of the invention disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems which involve AB testing on edge computing systems are described herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Throughout the present disclosure the term “edge request” refers to a request that is initiated by a node/computing device in an edge computing system. The edge request can comprise a reference to a webpage, resource, URL, etc., which is available at an origin server. Generally, the edge request is for resource types like HTML files, images, CSS stylesheets, JavaScript files, and other resources that make up a web page. The edge request also contains requests for content that is generated on-demand based on user input or other variables. This may include database queries, form submissions, or other interactions that require processing on the server side. Edge nodes may also communicate with each other for tasks like load balancing, data synchronization, or sharing processing tasks. Communication between edge nodes may also involve the synchronization or replication of data between different edge nodes to ensure consistency and redundancy. The types of requests in an edge computing environment can vary depending on the specific application and the architecture in use.

An edge computing node refers to a device or a server located at the edge of a network, closer to the data source or end-user devices than an origin server. These nodes can be responsible for processing, storing, and analyzing data locally, rather than sending it to a centralized cloud server for processing. An edge system refers to a centralized or distributed computing architecture that cooperates with one or more origin servers and extends computation and data storage closer to the sources of data generation, consumption, or processing. An edge network typically consists of a decentralized collection of computing resources distributed geographically.

A client device can be any device used to access content on a network. For example, the client device can be a smartphone or laptop computer being used to access content from the internet. User and client are used interchangeably in this entire description and refer to a user of a computing device that requires a resource administrated by an origin server (e.g., a client device).

An origin server is a key component in edge computing architectures. As used in this disclosure an origin server can refer to the original source of the HTML webpage or processing power for a website or application. The origin server can be where the HTML webpage is initially stored and maintained. The origin server can be in a centralized data center, often in a cloud environment or a dedicated server infrastructure. The origin server can be responsible for storing the master copies of web pages, images, videos, and other resources that make up a website or application and it is where updates and changes to the HTML webpage are made.

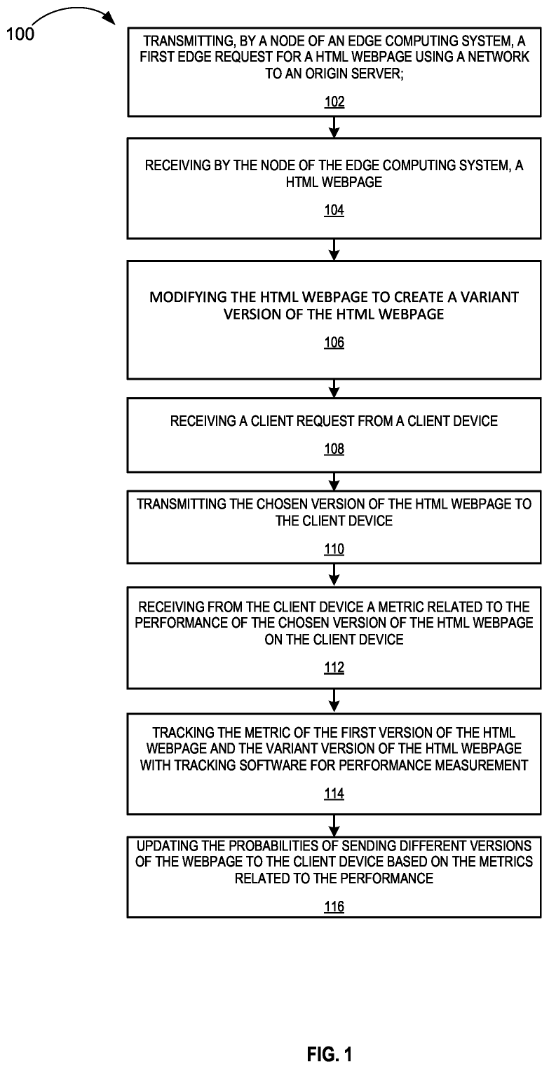

FIG. 1 illustrates a flow chart 100 describing the steps implemented by an edge computing system in accordance with specific embodiments of the invention disclosed herein. Flow chart 100 comprises computer-implemented steps 102, 104, 106, 108, 110, 112, 114, 116 and 118. At step 102, a node of the edge computing system transmits a request for an HTML webpage using a network. The webpage can be generally referenced using a Uniform Resource Locator (URL) and can contain headers. Each request from the edge node is reciprocated by a response containing the requested HTML webpage from the origin server. In specific embodiments, the administrator of the origin server inputs layout configuration from a WYSIWYG (What You See Is What You Get) interface to create the HTML webpage that is sent to the edge node. At step 104, the edge node receives via the network a first version of an HTML webpage and caches this first version at the edge node to allow for retrieval by client devices with low latency. Although various types of cache storages like CPU caches, web caches, database caches, and content delivery network (CDN) caches can be used, it is preferable to use web caches for the current application scenario, as web caches are generally used to store web page content (HTML, images, scripts) on a local server to reduce the load on the origin server and improve webpage load times for users.

At step 106, the HTML editing module implemented by computer executable instructions stored in the hard disk of the edge node and loaded into the random-access memory at run-time modifies the first version of the HTML webpage to create a variant version of the HTML webpage for experimentation purposes. The source code of the first version of the HTML webpage can be retrieved from the hard drive of the edge node where it was cached and loaded into the HTML editing module. In specific embodiments, the HTML editing module uses a WYSIWYG interface loads the first version of the HTML webpage retrieved from the hard drive and presents it in a window for editing and edits to the webpage are stored as HTML and JavaScript back in the hard drive of the edge node. Editing the webpage can involve iterating through style tags of the HTML source code to normalize the layout features according to the parameters of the experimental input. In specific embodiments, the HTML editing module uses generative AI to load the first version HTML source code retrieved from the hard drive and modify the source code of the HTML webpage to automatically tunes the style tags to create a variant version of the HTML webpage to display to the end users of the experiment. In specific embodiments, the inputs to the generative AI expound the parameters of the AB test such as a layout description of a user interface associated with the experiment. The generative AI can also modify things such as the images, copy, and layout of the HTML webpage. In specific embodiments, the input to the generative AI defines a key performance indicator, such as conversion rate, click-through rate, or the amount of revenue generated to optimize the HTML webpage.

At step 108, a client using a client device sends a request for accessing a HTML webpage on an origin server and the same is received by the edge node via a URL (uniform resource locator). In specific embodiments, the URL of the client request includes UTM (Urchin Tracking Module) parameters indicating the source of the user traffic. In specific embodiments, the UTM parameters of the request coordinate a version of the HTML webpage to respond with. As used herein, the term hypertext markup language encoding can be an encoding which includes the use of other languages such as JavaScript and the resources referenced by the encoding as well as other resources such as image files. At step 110, The edge node chooses either the original or variant version of the HTML webpage based on predetermined probabilities from a set of probabilities of sending different versions.

At step 112, the edge node receives from the client device a metric related to the performance of the version of the HTML webpage transmitted to the client device. The metric, sometimes known as a key performance indicator, can be whether or the number of times a user clicks a call to action over a pre-determined period, the amount of revenue generated by users via the HTML webpage, the length of session for the user or a set of users, etc. This metric can be defined by the administrator at the origin server prior to the start of the experiment. In specific embodiments, the metric is stored in a database of the web cache of the edge node.

At step 114, the tracking software for performance measurement tabulates the metric received from the client device. In specific embodiments, the tracking software for performance is implemented by computer executable instructions stored in the hard disk of the edge node and loaded into the random-access memory at run-time. In specific embodiments, each time a new metric is stored in the web cache of the edge node, the tracking software for performance measurement uses an in-place sorting algorithm to reorganize the aggregated metric stored in the web cache. This involves loading metrics from web cache into random-access memory, inserting the new metric with the latest timestamp into the tabulated metrics and applying a sorting algorithm to reorganize the metrics. In specific embodiments, the tracking software for performance measurement normalizes the performance of the versions of the HTML webpage.

At step 116, the edge-side bias module updates the set of probabilities of sending different versions of the webpage to the client device based on the metrics related to performance. In specific embodiments, the edge-side bias module is implemented by computer executable instructions stored on the hard disk of the edge node and loaded into random-access memory at run-time. In specific embodiments, upon the client device uploading a metric related to the performance of the HTML webpage on the client device, the edge-side bias module iterates through the set of probabilities and calculates the likelihood of choosing a version of the HTML webpage based on the positivity of the key performance indicator for the version of the HTML webpage. In specific embodiments, the key performance indicator of the variants is normalized for the change in frequency through the course of the test such by comparing percentages of positive results for a design to number of times a design is presented as the metric for performance. The normalization algorithm accounts for the lower chance of success for versions of the HTML webpage that have been transmitted to the client device less.

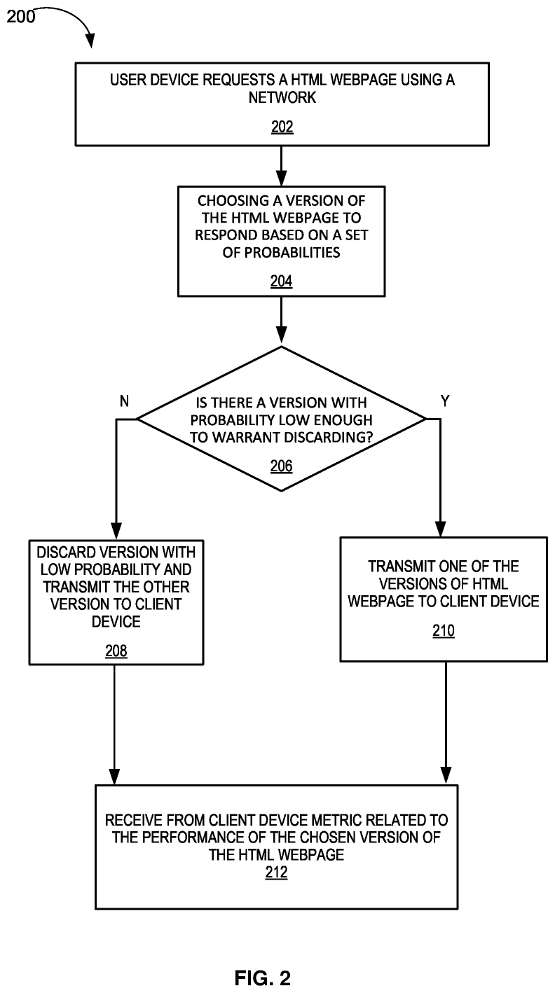

FIG. 2 illustrates a flow chart 200 describing a process implemented by the computer implemented method of the edge computing system in accordance with specific embodiments of the invention disclosed herein. At step 202, a user requests a HTML webpage from a client device of the edge computing system using a network. At step 204, the edge node receiving the request deploys the AB testing module, an application layer program stored in the hard drive of the edge node, to iterate through the versions of the HTML webpage and choose a version based on the set of probabilities. In specific embodiments the selection process can involve using a random number generator to pick a number between 0 and 100. Where the probabilities of choosing each version of the HTML webpage are normalized so that they aggregate to 100. Wherein the number output by the random number generator pinpoints one version of the HTML webpage to transmit to the client device. An example pseudocode to choose a version of the HTML webpage is provided below:
choose webpage( )
   generate random number from 0 to 100
   generate map of integer to HTML webpage
   select version of HTML webpage from number

### Example Map of Integer to HTML Webpage

| Key (percentage) | Value (HTML webpage) |
|---|---|
| 0-30 | Origin server version |
| 31-60 | Modified version |
| 61-85 | AI generated version |
| 86-99 | High performing version from edge node |

At step 206, the discard module, an application layer program stored in the hard drive of the edge node, iterates through the set of probabilities of all the versions of the HTML webpage and filters the versions with probabilities below a pre-defined percentage threshold. The versions that fall below the threshold are deleted from the hard disk of the edge node. In specific embodiments, the edge node transmits, using a network, an update to the origin server indicating which version of the HTML webpage has a probability below the threshold and has, as a result, been discarded.

At step 208 and 210, the edge node transmits a version of the HTML webpage that with an assigned probability above the pre-determined threshold to the client device. In specific embodiments. At step 212, the KPI module, implemented by computer executable instructions stored in the hard disk of the edge node and loaded into the random-access memory at run-time, receives the metrics or KPI (key performance indicators) transmitted by the client device to the edge node through a network.

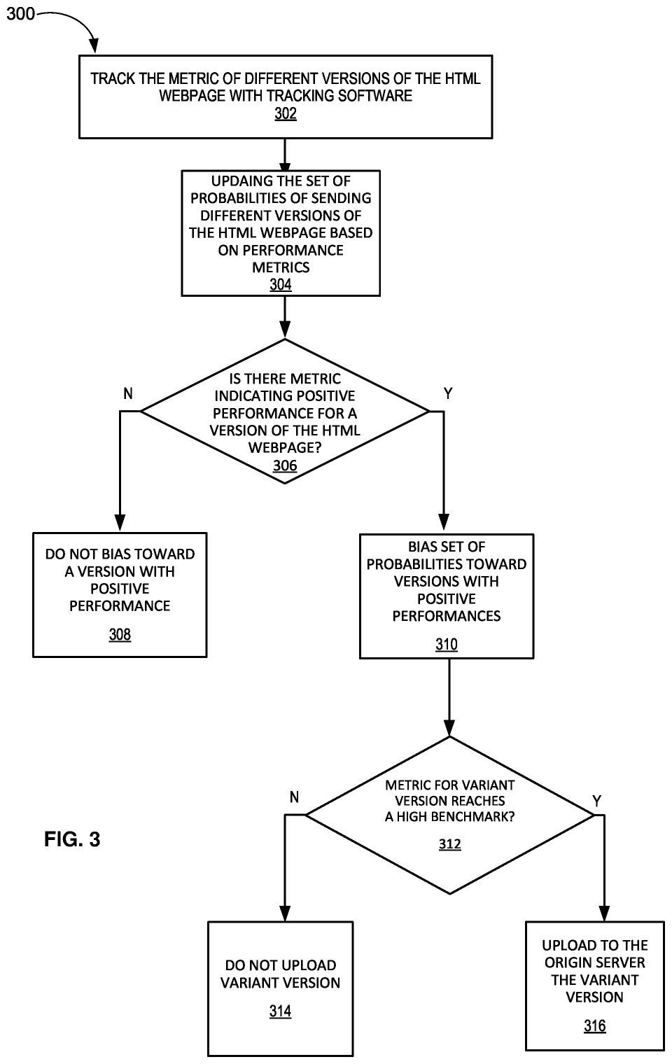

FIG. 3 illustrates a flow chart 300 describing a process implemented by the computer implemented method of the edge computing system in accordance with specific embodiments of the invention disclosed herein. At step 302 the tracking software for performance measurement uses a polling algorithm to monitor metrics each time they are stored in the database of the web cache of the edge node. At step 304, the tracking software for performance measurement updates the set of probabilities of sending different versions of the HTML webpage based on performance metrics. In specific embodiments, the tracking software for performance measurement loads the metric from the database of the web cache of the edge node before iterating through the set of probabilities and executing an algorithmic update of the probability of the version of the HTML webpage related to the metric.

At step 306, the tracking software for performance measurement compares the loaded metric with a predefined threshold related to the particular goal of the experiment. In specific embodiments, the threshold is predefined by the administrator of the origin server when setting up the experiment. If the metric loaded from the web cache exceeds the predefined threshold, the tracking software for performance passes the relevant identifying information to the edge-side bias module for processing. In specific embodiments, the URL of the version of the HTML webpage sent to the client device reporting the metric exceeding the predefined threshold is passed as a variable to the edge-side bias module. At step 308, when the metric loaded from the web cache does not exceed the predefined threshold, no relevant identifying information is sent to the edge-side bias module for processing. The metric loaded from the web cache is stored back into the web cache.

At step 310, the edge-side bias module iterates through the set of probabilities and adds percentage biases to those probabilities associated with high performance metrics to continuously optimize webpage delivery. In specific embodiments, the values of bias percentages added to the probabilities are 3%, 5%, or 10%. In specific embodiments, the values of bias percentages are predefined by the administrator of the origin server when setting up the experiment. The values of bias percentages added to the probabilities can also be weighted based on the distribution of the set of probabilities so that the bias is greater for higher probabilities. The values of bias percentages added to the probabilities can also be proportional to the magnitude of the high-performance metrics received from the client devices. The values of bias percentages added to the probabilities can also increase over the course of an experiment to present the positively performing versions of the HTML webpage with increasing frequency. This preserves the key performance indicators of the live site in the short-term during the experiment.

At step 312, an edge-side upload module compares the performance metric received from the client device with a high-performance benchmark predefined by the administrator of the origin server when setting up the experiment. At step 314, if the edge-side upload module determines that the performance metric does not exceed the high-performance benchmark for the performance metric, then the edge-side upload module does not upload this version of the HTML webpage to the origin server. At step 316, however, if the edge-side upload module determines that the performance metric does exceed the high-performance benchmark for the performance metric, then the edge-side upload module does upload this version of the HTML webpage to the origin server.

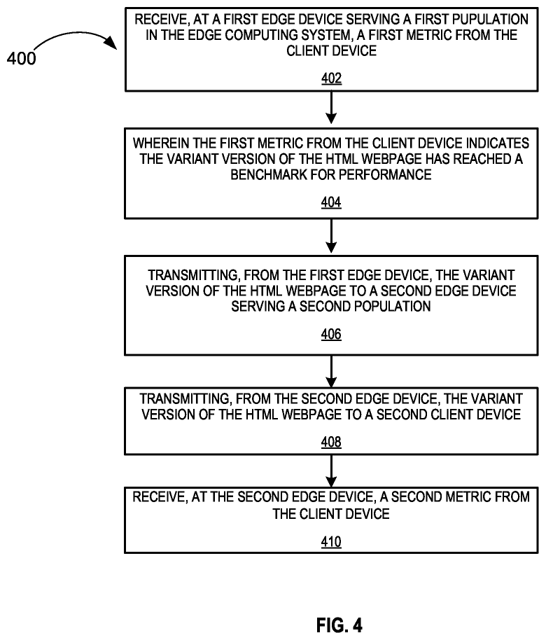

FIG. 4 illustrates a flow chart of an edge node sending a high performing variant version of an HTML webpage to another edge node for testing. At step 402, a first edge device serving a first population in the edge computing system receives a first metric from a client device related to a key performance indicator. At step 404, the KPI module, implemented by computer executable instructions stored in the hard disk of the edge node and loaded into the random-access memory at run-time, receives a metric from a client device that, when tallied with the existing metrics cached at the KPI module, indicates that the variant version of the HTML webpage has reached a benchmark for performance. The benchmark for performance can be predefined by the administrator of the origin server before the start of the experiment. For example, the benchmark for performance can be a KPI such as 20% of users spent $100 via the HTML webpage. Alternatively, the benchmark for performance can be a KPI such as 25% of users spent 90 seconds on the HTML webpage. In an alternative embodiment, the benchmark for performance can be a KPI such as 30% of the user clicking on the sign-up flow to register with the website. At step 406, the first edge device transmits this locally high performing version of the HTML webpage to a second edge device serving a second population. In an alternative embodiment, the benchmark for performance was received from another edge device as the global benchmark for performance and the first edge device transmits the local variant version of the HTML webpage to a second edge device if the performance of the local variant exceeds the global benchmark for performance. At step 408, the edge device that received the variant version of the HTML webpage from the first edge device transmits the HTML webpage to a second client device. At step 410, a second edge device serving a second population in the edge computing system receives a second metric from a client device related to a key performance indicator.

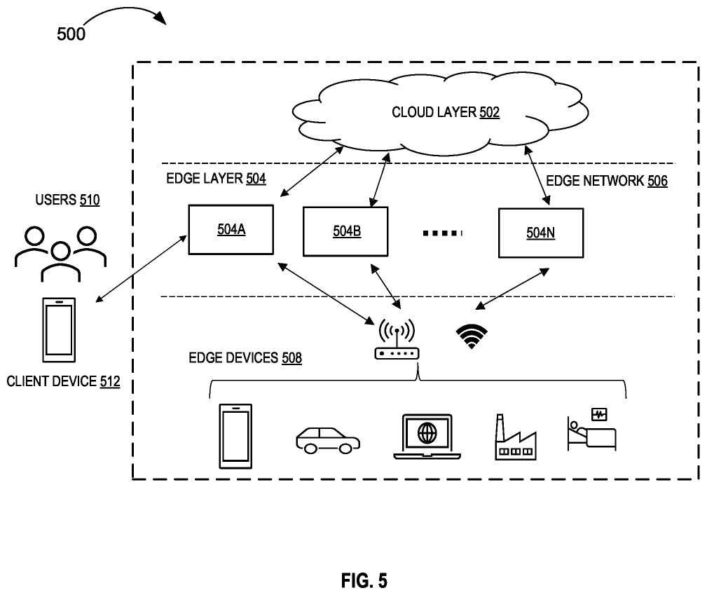

FIG. 5 illustrates the overall system architecture of the edge computing system 500 in accordance with specific embodiments of the invention disclosed herein. The first layer 502 comprises one or more origin servers in a cloud-based network. The cloud layer is connected to edge layer 504 via edge network 506. One or more edge nodes/computing devices 504A, 504B . . . 504N are connected to the edge network and comprises resources (hardware/software) to process the requests made by users 510 on client devices 512 and edge devices 508 using the edge network. The edge nodes/computing devices comprises edge caches (not shown here) that are configured to store the static content and genericized version of webpages for faster delivery to client devices, based on request from specific user of the client device.

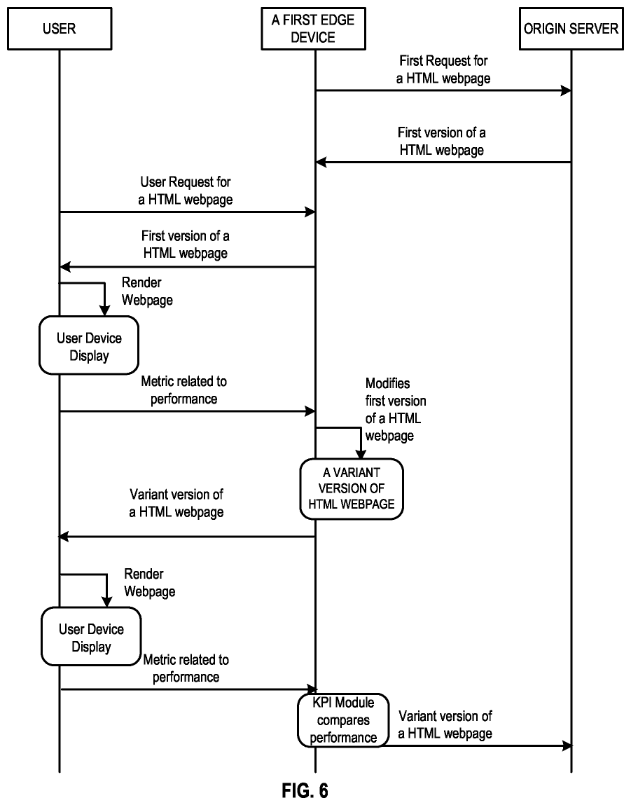

FIG. 6 illustrates a ladder diagram of a client device, an edge node, and an origin server conducting methods that are in accordance with specific embodiments of the invention disclosed herein. The first edge node makes a request to the origin server for a version of a HTML webpage through the network. The origin server is configured by an administrator to respond with a first version of the HTML webpage. The first edge node caches the first version of the HTML webpage locally. Subsequently, a user at a client device makes a request for a HTML webpage to the edge node. The edge node loads the version of the HTML webpage from the local cache and transmits the first version of a HTML webpage to the user at the client device. Subsequently, the client device loads the HTML renders the webpage to the user device display for the user to interact with. Based on the user's interaction with the local variant of the HTML webpage, metric related to performance is transmitted to the edge node.

The approaches disclosed herein exhibit significant benefits in that the AB testing can be conducted on multiple edge nodes of an edge computing system where each edge node services a different population. While specific approaches disclosed herein bias the delivery of HTML webpages towards pages that appear to be increasing an observed metric, and thereby do not perform a statistically fair test of the different versions, this bias is counteracted by the fact that it is deployed on a controlled subpopulation. While bias in the testing may have the potential to converge towards a solution that is not a true global optimal, the solution is not applied across all the nodes of the network which leaves the other edge nodes to continue to explore the space of optimal solutions and potentially still find the true global optimal. Furthermore, since the edge nodes are all administrated as part of an edge system, a supervisor layer can detect when a specific node has fallen into a false local optimal solution by periodically comparing performance metrics across different nodes in the overall edge computing system. The supervisor layer could send out a periodic poll to all the edge nodes to determine if a given variation which was currently favored by an errant edge node was suboptimal when compared with a given variation which was currently favored by another node. The term errant edge node is here used to refer to the fact that the node has mistakenly, because of the biased nature of the AB testing, been optimized towards a local optimal that is not a true global optimal version. At this point, the supervisor layer could then effectively recalibrate the errant node by providing it with the version of the web page that was proven, on a different node, to have superior performance metrics to the one being held and favored by the errant node.

The HTML editing module at the edge node modifies the first version of a HTML webpage to create a variant version of the HTML webpage to transmit to the user for rending at the user device display. Subsequently, metric related to the performance of the variant version of the HTML webpage is transmitted back to the edge node, where the KPI module, implemented by computer executable instructions stored in the hard disk of the edge node and loaded into the random-access memory at run-time, compares the performance of the variant version of the HTML webpage to a predefined benchmark and determines whether to upload a high performing variant version of the HTML webpage to the origin server.

The means for executing the method steps in the computer-implemented methods disclosed above can include an edge computing system. The edge computing system can be a distributed edge computing system. A distributed edge computing system can include multiple networked computing devices that operate together as part of a content delivery network to provide content from customers of the content delivery network to client devices. The customers of the content delivery network can use the edge computing systems to deliver content in the form of webpages and other content that can be distributed over a network to clients that request the webpages and other content.

An edge computing system in accordance with this disclosure can include a combination of specific hardware and software to ensure efficient and responsive performance. On the hardware side, the edge computing system can include processors, sufficient memory (e.g., RAM), and storage capabilities to handle data processing and caching. The edge computing system can also include specialized network interfaces, such as Ethernet or wireless connectivity, for communication with the broader network, origin servers, and client devices. The edge computing system may also incorporate security features like hardware-based encryption and secure boot mechanisms to protect sensitive data. Furthermore, an edge computing system can include accelerators like GPUs or FPGAs to handle computationally intensive tasks and facilitate real-time processing.

An edge computing system in accordance with this disclosure can also include software for the operation of edge computing systems. The edge computing system can include an optimized operating system, designed for low-latency and high-throughput tasks. The edge computing system can also include software platforms and frameworks, such as Docker or Kubernetes, used for containerization and orchestration, enabling efficient application deployment and scaling. The edge computing system can also include content delivery and caching software, like Nginx or Varnish, to store and serve web content quickly. The edge computing system can also include monitoring and management tools to ensure the health and performance of the system, with solutions like Prometheus and Grafana aiding in real-time data analysis and system maintenance. The edge computing system can include security software, including firewalls, intrusion detection systems, and encryption protocols, to safeguard both the device and the data it handles.

The edge computing systems disclosed herein can include a means for transmitting a first edge request for a HTML webpage using a network to an origin server. The means can include a processing unit, such as a high-performance CPU, memory modules, including RAM and storage devices, and network interfaces, such as Ethernet or wireless adapters, which enable the system to establish reliable connections with the origin server, ensuring efficient data transfer. Additionally, the means can include specialized software components, like edge computing frameworks and communication protocols, which orchestrate the flow of information between the edge system and the origin server. Security features, including encryption and authentication mechanisms, can safeguard the data during transit. Together, these components form a robust edge means for transmitting that optimizes data processing and communication, enhancing the overall efficiency and responsiveness of the edge computing infrastructure.

The edge computing systems disclosed herein can include a means for receiving from the origin server a first version of the HTML webpage. The means for receiving the first version can include network interfaces which enable the server to establish and maintain connections with the origin server, ensuring a seamless flow of data. Once the data arrives, the processing unit, typically a CPU, can take charge of executing complex computational tasks such as storing the first version of the HTML webpage in a repository in association with tags that identify the webpage of which it is a version. The means can also include memory modules, such as RAM, which play a pivotal role in temporarily storing and accessing data during processing, enhancing the server's responsiveness. Specialized software components, including edge computing frameworks and communication protocols, can also be part of the means for receiving and manage the communication flow and orchestrate the processing tasks. Moreover, security features such as firewalls and encryption mechanisms can also be part of the means for receiving and ensure the integrity and confidentiality of the data being received and processed. These integrated components collectively empower the edge computing server to efficiently handle incoming communications, providing real-time processing capabilities and reducing latency in the overall system.

The edge computing systems disclosed herein can include a means for modifying the first version of the HTML webpage to create a variant version of the HTML webpage. The means for modifying can be the WYSIWYG interfaces or generative AI systems described above. The means for modifying can also be an automated content management systems (CSM) that is customized to make the kinds of modifications required to test different versions of a web page in accordance with the approaches disclosed herein. Once modifications are selected, the CMS can trigger a series of actions to optimize the webpage for edge delivery. This may involve content caching, where frequently accessed elements are stored at edge nodes closest to the end-users, reducing latency. Additionally, the CMS may employ content delivery network (CDN) integration, ensuring that static resources are distributed across edge servers for quicker retrieval. The CMS can also collaborate with edge computing frameworks to enhance dynamic content processing at the edge, reducing the burden on the origin server and minimizing latency. Security measures, such as encryption and authentication protocols, are often implemented during this process to ensure the integrity and confidentiality of the delivered content. In essence, the CMS in an edge computing system plays a pivotal role in modifying and optimizing webpages, tailoring them for swift and responsive delivery to end-users.

The edge computing systems disclosed herein can include a means for receiving a client request from a client device. The means for receiving a client request from a client device are the components of an edge server responsible for receiving and processing requests from client devices. As a client device sends a request, network interfaces serve as the entry point, establishing a connection with the edge server. The processing unit, typically a high-performance CPU, takes charge of executing the requested operations swiftly. Memory modules, including RAM, play a crucial role in temporarily storing and retrieving data during the processing phase, optimizing response times. Specialized software components, such as edge computing frameworks and communication protocols, manage the flow of information, ensuring seamless interactions between the client device and the server. Security features, including encryption and authentication mechanisms, safeguard the communication channel and data integrity. The integrated components work collaboratively to process the client's request efficiently, leveraging the proximity of the edge server to the client device to minimize latency and enhance the overall user experience.

The edge computing systems disclosed herein can include a means for choosing either the first version or the variant version of the HTML webpage to respond based on a probability. These means can include the methods of flow chart 200 described with reference to step 204 including the AB testing module, the application layer program, and the pseudocode provided for selecting a chosen version of the HTML webpage.

The edge computing systems disclosed herein can include a means for transmitting the chosen version of the HTML webpage to the client device. The means for transmitting the chosen version can be similar to the components used to receive a request from a client device. Indeed, the means for transmitting can be the hardware and software used to support the session created by the client request, and the session itself.

The edge computing systems disclosed herein can include a means for receiving from the client device a metric related to the performance of the chosen version of the HTML webpage on the client device. The means for receiving the metric from the client device can include the means for receiving the request from the client device as the data can be obtained via the same session. For example, the means can include an AJAX request handler or a server-side application or script for processing incoming HTTP requests or cookies sent by the client device.

The edge computing systems disclosed herein can include a means for tracking the metric of the first version of the HTML webpage and the variant version of the HTML webpage with tracking software for performance measurement. The means for tracking can be the tracking software described with reference to step 302 above and the supporting software and hardware on the edge computing device.

The edge computing systems disclosed herein can include a means for updating the probability of sending different versions of the client based on their associated metrics. The means can include an edge-side bias module as described above with reference to step 310 and the associated hardware and software used to communicate with the module.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

What is claimed is:

1. A computer-implemented method executed by an edge computing system, the computer-implemented method comprising:
transmitting a first edge request for a HTML webpage using a network to an origin server;
receiving from the origin server a first version of the HTML webpage;
modifying the first version of the HTML webpage to create a variant version of the HTML webpage;
receiving a client request from a client device;
choosing either the first version or the variant version of the HTML webpage to respond to the client request based on a probability from a set of probabilities of sending different versions of the HTML webpage;
transmitting the chosen version of the HTML webpage to the client device;
receiving from the client device a metric related to the performance of the chosen version of the HTML webpage on the client device;
tracking the metric for the first version of the HTML webpage and the variant version of the HTML webpage with tracking software for performance measurement; and
updating, using an edge-side bias module, the set of probabilities of sending different versions of the HTML webpage based on the metrics related to the performance;
wherein the set of probabilities is updated to test different variants of the HTML webpage, and the set of probabilities is biased towards variants that are associated with high metrics of performance.

2. The computer-implemented method of claim 1, wherein the modifying the first version of the HTML webpage includes using generative AI to create the variant version of the HTML webpage.

3. The computer-implemented method of claim 1, wherein modifying the first version of the HTML webpage includes using a WYSIWYG interface to create a modified version of the HTML webpage.

4. The computer-implemented method of claim 1, wherein the edge computing system is a distributed edge computing system.

5. The computer-implemented method of claim 1, wherein tracking the metric of the first version of the HTML webpage includes tracking the conversion rate of a plurality of users of the HTML webpage.

6. The computer-implemented method of claim 1, wherein the tracking the metric of the first version of the HTML webpage includes tracking the average time spent on the page of a plurality of users of the HTML webpage.

7. The computer-implemented method of claim 1, wherein the tracking the metric of the first version of the HTML webpage includes tracking the average amount of revenue generated on the page from a plurality of users of the HTML webpage.

8. The computer-implemented method of claim 1, wherein:
updating the probability of sending a version of the HTML webpage to the client comprises increasing the probability of sending that version of the HTML webpage upon the metric measurement received from the client device indicating positive performance.

9. The computer-implemented method of claim 1, wherein:
the computer-implemented method is executed by a plurality of edge devices; and each edge device of the distributed edge computing system serves a population of users with its own variant version of the HTML webpage.

10. The computer-implemented method of claim 9, further comprising:
receiving, at a first edge device serving a first population in the edge computing system, a first metric from the client device which indicates the variant version of the HTML webpage has reached a benchmark for performance; and transmitting, from the first edge device, the variant version of the HTML webpage to a second edge device serving a second population;
and transmitting, from the second edge device, the variant version of the HTML webpage to a second client device.

11. The computer-implemented method of claim 1, wherein the set of probabilities is updated using an edge-side bias module that normalizes the metric for performance.

12. The computer-implemented method of claim 1, wherein receiving from the origin server a first version of the HTML webpage comprises receiving a different first version of the HTML webpage transmitted to the origin server from another edge server.

13. The computer-implemented method of claim 1, further comprising:
uploading to the origin server the variant version of the HTML webpage when the metric related to the performance of the variant version of the HTML webpage reaches a pre-defined high benchmark.

14. The computer-implemented method of claim 1, wherein updating the set of probabilities comprises discarding a low performing version of the HTML webpage when a probability associated with the low performing version reaches a low benchmark.

15. One or more non-transitory computer-readable media storing computer executable instructions that, when executed by an edge computing system, causes the edge computing system to execute a computer-implemented method comprising:
transmitting a first edge request for a HTML webpage using a network to an origin server;
receiving from the origin server a first version of the HTML webpage;
modifying the first version of the HTML webpage to create a variant version of the HTML webpage;
receiving a client request from a client device;
choosing either the first version or the variant version of the HTML webpage to respond based on a probability;
transmitting the chosen version of the HTML webpage to the client device;
receiving from the client device a metric related to the performance of the chosen version of the HTML webpage on the client device;
tracking the metric of the first version of the HTML webpage and the variant version of the HTML webpage with tracking software for performance measurement;
updating the probability of sending different versions of the client based on their associated metrics using an edge-side bias module.

16. The one or more non-transitory computer-readable media of claim 15, storing computer executable instructions that are executed by a plurality of edge devices wherein:
sending a version of the HTML webpage to the client comprises increasing the probability of sending that version of the HTML webpage upon receiving metric indicating positive performance.

17. The one or more non-transitory computer-readable media of claim 15, storing computer executable instructions that are executed by a plurality of edge devices wherein:
each edge device serves a population of users with its own variant version of the HTML webpage.

18. The one or more non-transitory computer-readable media of claim 15, wherein receiving from the origin server a first version of the HTML webpage comprises receiving a different first version of the HTML webpage transmitted to the origin server from another edge server.

19. The one or more non-transitory computer-readable media of claim 15, wherein updating the set of probabilities comprises discarding a low performing version of the HTML webpage when a probability associated with the low performing version reaches a low benchmark.

20. An edge computing system comprising:
a means for transmitting a first edge request for a HTML webpage using a network to an origin server;
a means for receiving from the origin server a first version of the HTML webpage;
a means for modifying the first version of the HTML webpage to create a variant version of the HTML webpage;
a means for receiving a client request from a client device;
a means for choosing either the first version or the variant version of the HTML webpage to respond based on a probability;
a means for transmitting the chosen version of the HTML webpage to the client device;
a means for receiving from the client device a metric related to the performance of the chosen version of the HTML webpage on the client device;
a means for tracking the metric of the first version of the HTML webpage and the variant version of the HTML webpage with tracking software for performance measurement; and
a means for updating the probability of sending different versions of the client based on their associated metrics using an edge-side bias module.
